(19) United States
(12) Patent Application Publication
(10) Pub. No.: US 2007/0122089 A1
(43) Pub. Date: May 31, 2007

(54) Optical assembly having fiber-abutting block

(76) Inventor: Shunsuke Sato, Yokohama-shi (JP)

Correspondence Address: SMITH, GAMBRELL & RUSSELL, 1850 M STREET, N.W., SUITE 800, WASHINGTON, DC, 20036, US

(21) Appl. No.: 11/436,975

(22) Filed: May 19, 2006

(30) Foreign Application Priority Data
May 19, 2005 (JP) P. 2005-146321

(51) Int. Cl. G02B 6/36

(52) U.S. Cl. 385/92; 385/88

(57) ABSTRACT

The optical assembly of the present invention suppresses the reflection occurred at the end face of the external fiber, which makes it simple to control the pressure of the glass block with a simplified shape and easily processed at the fitting into the housing. The optical assembly includes the sleeve to guide the external fiber, the glass block to suppress the reflection at the end surface of the external fiber, and the housing to secure the sleeve and the glass block. The housing provides a wall to receive the pressure applied from the optical connector securing the external fiber to the glass block, and the wall is assembled in the housing such that the surface of the glass block becomes in substantially perpendicular to the inner wall of the sleeve.

### BACKGROUND OF THE INVENTION

1. Field of the Invention

The present invention relates to an optical assembly that provides a mechanism for preventing reflected light from returning.

2. Related Prior Arts

FIG. 3 shows a conventional optical assembly. This optical assembly comprises a split sleeve 101, a stub 102, and a housing 104. Since the stub 102, with a single mode fiber (SMF) in a center portion thereof and an end thereof being formed in a convex shape, while, a tip of an optical fiber inserted from the outside of the optical assembly is formed in a convex shape to make, what is called, a physical contact (PC) with the end of the stub 102, the reflection between the interface therebetween may be suppressed. Moreover, since the other end of the stub 102, a side facing an optical device, is polished in bevel with a substantial angle to the optical axis of the optical fiber 103, the light reflected at the end of the stub 102 by the Fresnel reflection may not re-couple with the SMF 103 or the optical device.

In this arrangement, the parts cost of the stub 102 becomes quite high because the stub includes two members made of ceramic capillary, which corresponds to a sheath, and the SMF 103 and a plural processes, such as an assembling process and an polishing process, is necessary to manufacture the stub 102. Moreover, when the stub 102 in the end surface thereof is polished, a spare length is necessary to set the stub 102 in the processing apparatus, which elongates the stub 102 greater than 2 mm, about 3 mm in general, and expands the overall length of the optical assembly providing this stub 102. It is well known for the optical assembly that a transmitting optical sub-assembly (TOSA) installing a light-emitting device such as semiconductor laser diode therein and a receiving optical sub-assembly (ROSA) installing a light-receiving device such as photodiode therein. An optical transceiver using these optical sub-assemblies, such as SFP (Small Form Factor Pluggable) and XFP (10 gigabit small form factor pluggable) is standardized in its outer dimension in the business field by a multi-source agreement: MSA), and in order to incorporate various functions not ruled in the MSA into the optical transceiver, the optical subassembly is required to be small as possible.

On the other hand, the United States Patent, published as 2004/0086233A, has disclosed a method to suppress the optical reflection by using a glass block. An optical assembly shown in FIG. 4 corresponds to that disclosed in the gazette includes a housing 113, and, within this housing 113, a glass block 111 to suppress the light reflection occurred at the end surface of the optical fiber and a mount 112 for fixing the glass block 111 to the housing 113. The mount 112 forms a plurality of projection 114 in one side thereof, and by press-fitting the mount 112 into the housing 113 as squashing the projections 114, the glass block 111 is fixed against the housing 113. Since the projections 114 are elastically deformed in the press-fitting, the glass block 111 may be fixed without applying an excess stress to the glass block 111.

According to this arrangement, by applying the glass block with a simple structure and a good workability, the parts cost may be reduced. Moreover, since the glass block 111 may be thinned conparing to the stub shown in FIG. 3, this arrangement has advantage for miniaturizing the optical assembly.

For the optical assembly shown in FIG. 4 an optical connector set with an external fiber is inserted therein along an arrow A. The optical connector has a structure with a spring to generate a pressure on the tip of the external fiber. Accordingly, the glass block 111 receives a steady pressure along the arrow A. The glass block 111 and the mount 112 receive this steady pressure, and finally, the housing absorbs. The steady pressure reaches 10 N in the maximum for the LC-type connector. But, when the optical connector is inserted within the sleeve 116, a pressure greater than this maximum steady value may be applied instantaneously to the glass block 111, the mount 112, and the projections 114, accordingly, a structure for the press-fitting is required to take an enough safety factor into the consideration to bear such instantaneous pressure. Therefore, a control of the press-fitting of the projections 114 of the mount 111 into the housing 113 becomes important. Insufficient performance for holding the mount 112 by the housing 113 causes the falling of the mount 112 from the housing by the insertion of the optical connector into the sleeve 116.

Moreover, to suppress the Fresnel reflection occurred at the interface between the external fiber and the glass block 111, the external fiber is necessary to come in physically contact with the glass block 111. Accordingly, the surface 117 of the glass block 111 facing the external fiver must be in perpendicular to the optical axis of the external fiber. Moreover, for the housing 113, the surface 118 abutting against the glass block 111 of the housing 113 is processed in perpendicular to the side of the sleeve 116, and the mount 112 must be assembled with an accurate pressure such that the surface 117 of the glass block 111 facing the external fiber becomes in parallel to the surface 118. That is, it becomes important for the surface 18 to be in perpendicular to the side of the sleeve 116. In a case that an excess stress is affected to the mount 112, the glass block 111, which is more fragile than other parts, may receive an excessive stress to cause a breakage thereof.

Furthermore, as shown in FIG. 5, after the mount 112 is press-fitted into the housing 113, the mount 112 is inclined to the direction shown by the arrow B, and, when the glass block 111 is inclined following to the mount 112, the external fiber becomes hard to come in physically contact with the glass block. Under this condition, further pressing the mount 112 to fit into the housing 113, the glass block 111 may be broken by receiving the pressure only in one side 119 of the glass block 111. Or, even though the glass block 111 is not broken, it is assembled as tilted to the optical axis of the external fiber to make it hard for the external fiber to come in physically contact with the glass block 111, which becomes impossible to suppress the Fresnel reflection at the end of the external fiber.

The present invention is to provide a structure for an optical assembly that suppress the reflection occurred at the end of the external fiber and makes it unnecessary to control the fitting pressure of the block with a simple shape and easily processed into the housing.

### SUMMARY OF THE INVENTION

A feature of an optical assembly according to the present invention is that the optical assembly provides a sleeve for guiding an optical connector, A block to suppress the reflection occurred at an end of an external fiber secured by the optical connector, and a housing for holding the sleeve and the block. The housing includes a first portion for supporting an optical device, a second portion for supporting the sleeve, and a wall configured to divide the first portion from the second portion and to receive the pressure affected to the block at the insertion of the optical connector into the sleeve. The block receives the pressure by abutting against the wall, and the surface thereof abutting against the external fiber is substantially in perpendicular to the inside of the sleeve.

### BRIEF DESCRIPTION OF DRAWINGS

FIG. 1 shows a structure of the optical assembly according to an embodiment of the present invention;

FIG. 2 shows parts of the optical assembly illustrated in FIG. 1 before the assembling;

FIG. 3 shows a first example of the conventional optical assembly;

FIG. 4 shows a second example of the conventional optical assembly; and

FIG. 5 shows an example of the failure in the assembly for the optical assembly shown in FIG. 4.

### DESCRIPTION OF PREFERRED EMBODIMENTS

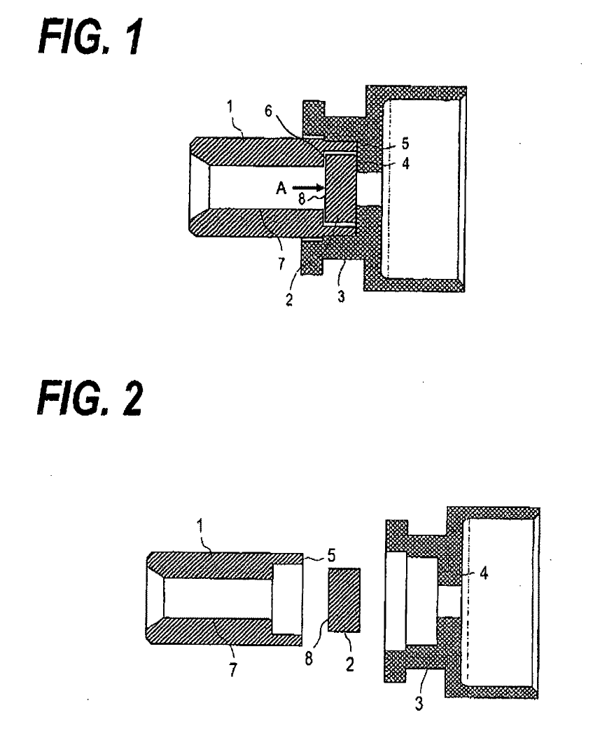

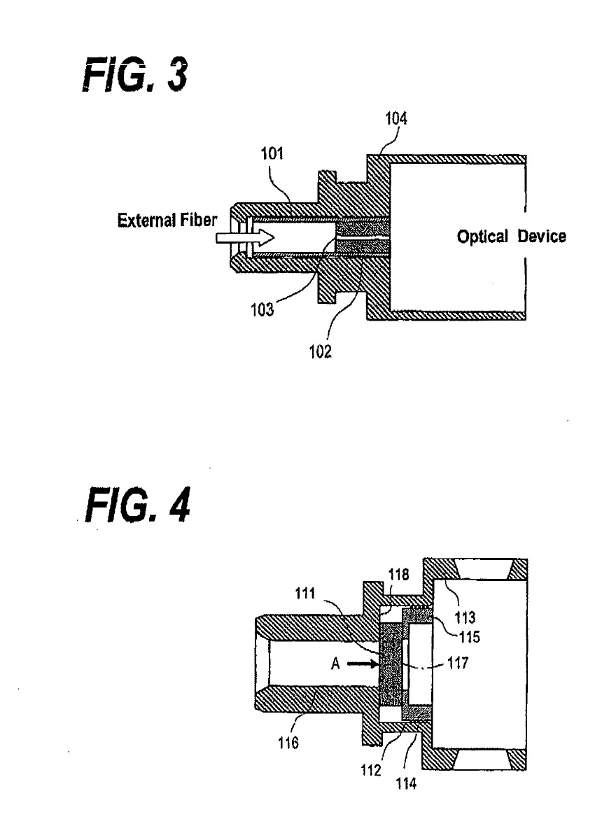

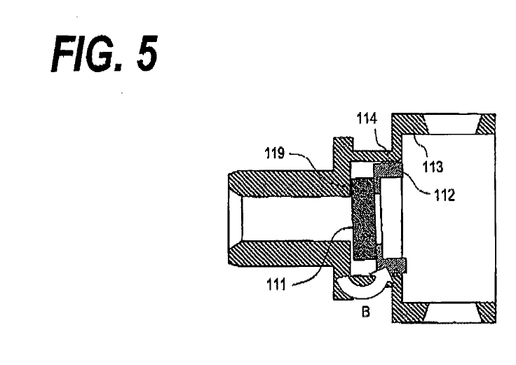

FIG. 1 shows a structure of an optical assembly 10 according to one example of the present invention. This optical assembly comprises a sleeve 1 operating as a guide for an optical connector securing an external fiber, a glass block 2 for abutting against the end of the external fiber to suppress the Fresnel reflection, and a housing 3 for fixing these sleeve land the glass block 2. In the optical assembly 10 of the present invention, a pressure applied from the optical connector to the glass block 2 by the insertion or the optical connector can be received by the whole housing 3. That is, the housing 3 includes a first portion 11 for securing an optical device, a second portion 12 for securing the sleeve 1, and a wall 4 configured to divide the first portion 11 from the second portion 12 and to receive the pressure applied to the glass block 2 from the optical connector, and this wall 4 may release the strict control of the strength at the press-fitting of the mount into the housing 3 to bear the stress applied from the optical connector.

The glass block 2, which is configured so as to be in closely contact with the wall 4 of the housing 3, while, the assembly of the sleeve with the housing 3 is carried out such that the end surface 5 of the sleeve 1 comes in closely contact with the wall 4 of the housing 3. Between the sleeve 1 and the glass block 2 is formed with a slight gap 6. Accordingly, the pressure caused by the insertion of the sleeve 1 into the housing 3 is not directly affected to the glass block 2. Therefore, even by the press-fitting, in other words, by a process accompanied with a pressure, the glass block 2 may be escaped from the breakage. The optical connector engaged with the optical assembly 10 is slid on the inner wall 7 of the sleeve 1, and the end of the external fiber secured by the optical connector comes in physically contact with the surface 8 of the glass block 2. In this insertion, it may be important that the inner wall 7 of the sleeve 1 becomes in perpendicular to the surface 8 of the glass block 2.

FIG. 2 is an exploded view showing parts or the optical assembly before assembling. As shown in FIG. 1, the glass block 2 is assembled with the housing 3 so as to abut against the wall 4, and the sleeve 1 is also assembled with the housing 3 so as to abut in the end surface 5 thereof against the wall 4.

The end surface 5 of the sleeve 1 becomes in parallel to the surface 8 of the glass block 2 because the sleeve 1 and the glass block 2 are assembled through the wall 4 of the housing 3. Moreover, the sleeve 1 is formed such that the inner wall 7 becomes in perpendicular to the end surface 5 thereof. Consequently, the inner wall 7 becomes in perpendicular to the end surface 8 of the glass block 2, whereby the end of the external fiber may abut against the surface 8 of the glass block 2 to suppress the Fresnel reflection.

The Fresnel reflection Rf occurred at the end of the external fiber is derived from the difference of the refractive index of materials and indicated by:
Rf=10×log₁₀{(n₁−n₂)²/(n₁+n₂)²} [dB],
where n₁ and n₂ are the refractive index of the core of the external fiber and that of the glass block 2, respectively. The permissible limit of the Fresnel reflection is internationally ruled, for example, the ITU-T standard specifies the value −27 dB in the maximum. Because the refractive index n₁ of the core of the external fiber, which is generally the single mode fiber, is 1.47, the refractive index n₂ of the glass block 2 requires from 1.35 to 1.59 to obtain the Fresnel reflection below −27 dB. A transparent resin, glass, and ceramics may be used as the glass block 2.

The interface between the glans block 2 and the air also causes the Fresnel reflection. However, the light emitted from the end of the external fiber, namely, the interface of the glass block 2, propagates within the glass block 2 as dispersing. Accordingly, even if a part of the light reflected at the other surface of the glass block 2 by the Fresnel reflection re-couples with the external fiber, the magnitude thereof may be suppressed by forming the glass block 2 thick. When the glass block 2 is unable to configure thick enough, the surface of the glass block 2 in the side of the housing 3, the other surface thereof, maybe provided with an anti-reflecting coating to suppress the Fresnel reflection thereat.

The sleeve 1 is necessary to be processed the inner wall 7 thereof precisely to insert the optical connector correctly. To get enough accuracy, the sleeve 1 is preferable to be made of ceramics precisely workable or metal. A resin-made sleeve provides a good mass-productiveness.

The housing 3 is necessary to be made of material to bear the pressure at the insertion of the optical connector. For example, it is preferable to apply the metal or the ceramics. Further, the housing 3 is preferable to be made of electrically conductive material. Such material may operate as a shield for a noise leaking form the inside of the optical transceiver to the outside, or a noise coming from the outside.

For the fixing of the sleeve 1 to the housing 3, it is preferable to press-fit the sleeve 1 into the housing 3. An adhesive may be used when the press-fitting is unable to show the enough bond strength. The glass block 2, as one modification thereof, may have a structure that a center portion of the surface that faces the first portion 11 of the housing 3 and passes the light therethrough, except for the surface abutting against the housing 3, may be inclined by from about 5° to 10° to the optical axis of the external fiber.

The surface of the glass block 2 suppresses the Fresnel reflection by coming in physically contact with the external fiber. However, when the other surface of the glass block 2 is in perpendicular to the optical axis, which causes the Fresnel reflection, and the optical assembly is a transmitter optical sub-assembly (TOSA), the reflected light returns the light-emitting device and becomes an optical noise source. When the optical assembly is a receiver optical sub-assembly (ROSA), the reflected light returns the external fiber, which also becomes an optical noise. Accordingly, to incline the center portion of the surface of the glass block 2 facing the optical device by a few degrees to the optical axis of the external fiber becomes effective to reduce the optical reflection.

Thus, preferred embodiments of the present invention are described as referring to accompanying drawings. However, the present invention is not restricted to those preferred embodiments. Various modifications can be considered without departing from the scope of the invention. Accordingly, it is intended that the appended claims encompass any such modifications or embodiments.

What is claimed is:

1. An optical assembly, comprising:
a sleeve noting with an optical connector securing an external optical fiber;
a block with a surface coming in physically contact with the external optical fiber; and
a housing holding the sleeve and the block,
wherein the housing includes a wall abutting against another surface of the block.

2. The optical assembly according to claim 1,
wherein the sleeve includes an inner wall within which the optical connector is inserted and an end surface abutting against the wall of the housing, and
wherein the end surface is substantially in perpendicular to the inner wall.

3. The optical assembly according to claim 1,
wherein the sleeve is press-fitted into the housing.

4. The optical assembly according to claim 1,
wherein the sleeve and the block makes a gap therebetween.

5. The optical assembly according to claim 1,
wherein the block is made of glass.

6. An optical assembly for receiving an optical connector securing an external fiber in one end thereof and for installing an optical device in another end thereof to make the optical device to optically couple with the optical fiber, the optical assembly comprising:
a sleeve for receiving the optical connector in a side of the one end, the sleeve having a cylindrical inner wall and a cylindrical outer wall;
a housing including a first portion for installing the optical device in a side of the other end, a second portion for securing the sleeve in a side of the one end, and a wall for dividing the first portion from the second portion; and
a block held by the sleeve in a side of the other end thereof and abutting against the wall.

7. The optical assembly according to claim 6,
wherein the sleeve in a side of the other end thereof is press-fitted in to the second portion of the housing.

8. The optical assembly according to claim 7,
wherein the block and the inner wall of the sleeve makes a gap therebetween.

9. The optical assembly according to claim 6,
wherein a surface of the wall abutting against the block is in substantially perpendicular to the inner wall of the sleeve.
